(19) United States
(12) Patent Application Publication
(10) Pub. No.: US 2025/0361095 A1
(43) Pub. Date: Nov. 27, 2025

(54) CONVEYOR DEVICE, METHOD FOR OPERATION, AND USE

(71) Applicant: Deutsche Post AG, Bonn (DE)

(72) Inventors: Viktor KUZNECOV, Siegburg (DE); Frank FISSER, Köln (DE)

(21) Appl. No.: 19/213,374

(22) Filed: May 20, 2025

(30) Foreign Application Priority Data
May 22, 2024 (DE) 10 2024 114 361.4

(51) Int. Cl. B65G 43/02

(52) U.S. Cl. CPC B65G 43/02; B65G 2203/0275; B65G 2203/041

(57) ABSTRACT

A conveyor device for conveying objects includes a circulating conveyor line, along which a plurality of conveyor units and a maintenance unit are movably guided in a concatenated manner, wherein the conveyor units are each designed to unload an object resting thereon transversely to the conveyor line, and the maintenance unit includes an actuator unit for carrying out maintenance work on the conveyor line.

The present application is based upon and claims the right of priority to DE Patent Application No. 10 2024 114 361.4, filed May 22, 2024, the disclosure of which is hereby incorporated by reference herein in its entirety for all purposes.

The invention relates to a conveyor device for conveying objects. The invention furthermore relates to a method for operating a conveyor device for conveying objects and a use.

It is known that conveyed objects can jam or get lost in a conveyor device. On the one hand, this endangers the conveyor device as such or its proper operation. On the other hand, the proper conveyance of the objects is endangered.

Furthermore, conveyor devices have to be regularly maintained and repaired if necessary. For this purpose, a conveyor device regularly has to be switched off, complex manual activities have to be completed, and proper work protection has to be ensured.

Proceeding therefrom, it is the object of the invention to provide solutions using which the conveyance or the conveying of objects in conveyor devices is more successful. In particular, maintenance and repair in conveyor devices are to be improved. In particular, disadvantages in solutions known from the prior art are to be avoided or at least substantially reduced.

This object is achieved by the subject matter of the independent claims. In particular, the invention is defined in the independent claims. Preferred refinements of the invention are found in the dependent claims, in the figures, and in the following description.

Downtime in conjunction with conveyor devices can be reduced using the invention. The work protection during maintenance and repair and the long lifetime of the conveyor devices can likewise be improved. The invention possibly contributes to the conveyor device being able to be operated at higher speed or conveyor speed, because it is possible to react faster to problems. The embodiments of the invention can further improve the mentioned advantages.

In particular, a conveyor device for conveying objects is proposed, comprising a circulating conveyor line having one or more movable conveyor units for depositing the objects. The conveyor unit can be movably guided along the conveyor line. A plurality of conveyor units and a maintenance unit for detecting the conveyor line can be movably guided in a row along the conveyor line. In particular, the conveyor device comprises a/the maintenance unit for detecting the conveyor line, or a plurality thereof. In particular, the conveyor units are each designed for unloading an object resting or conveyed thereon transversely to the conveyor line. In particular, the conveyor device comprises a detection unit permanently installed on the conveyor line for detecting the conveyor unit and/or an object. The maintenance unit in particular comprises a sensor system for detecting the conveyor line to obtain information about an upper side and/or a lower side of the conveyor line. The maintenance unit in particular comprises an actuator unit for carrying out maintenance work on the conveyor line.

For example, the independent claim directed to the conveyor device proposes a transverse belt conveyor or transverse belt sorter having a plurality of conveyor cells, wherein one of the conveyor cells is replaced by a maintenance cell or maintenance unit, which comprises a, for example, remote-controllable tool for carrying out maintenance and repair. It is thus also possible to work on points in the conveyor or sorter which are difficult to access in a simplified manner using the maintenance cell.

In particular, a method for operating a/the conveyor device is proposed, the method comprising: moving the maintenance unit(s) and preferably the conveyor unit(s) along the conveyor line, and detecting the conveyor line by means of the maintenance unit to obtain the information, and in particular comparing the obtained information with previously known information about the conveyor line to check the function and/or alignment of the detection unit and/or to locate a geometrical deviation in the conveyor line.

For example, an operating method of a transverse belt sorter or transverse belt conveyor having a plurality of conveyor cells is proposed by the independent claim directed to the method, wherein one of the conveyor cells is replaced by a maintenance cell or maintenance unit which comprises a, for example, remote-controllable tool for carrying out maintenance and repair and the sensors for inspecting the conveyor line or sorter line. In the method, conveyor cells and maintenance cell are moved jointly or at equal speed, including standstill, while the maintenance cell inspects or sensorially detects the conveyor line or sorter line. In particular in normal operation of the transverse belt sorter, helpful information on the status can thus be obtained, by which the maintenance can be improved. In addition, maintenance and repairs can be carried out.

In particular a use is proposed of a, for example, remote-controllable maintenance unit having a sensor system for detecting a conveyor line of a conveyor device designed for conveying objects to obtain information about an upper side and/or a lower side of the conveyor line and/or having a sensor system for detecting a conveyor line of a conveyor device designed for conveying objects to locate a geometrical deviation in the conveyor line and/or having a sensor system for detecting a conveyor line of a conveyor device designed for conveying objects to check the function and/or alignment of a detection unit permanently installed on the conveyor line, which is designed to detect the conveyor unit and/or an object, and/or having an actuator unit for carrying out maintenance work on a conveyor line of a conveyor device designed to convey objects. The use in particular provides operation of the conveyor device moving the conveyor line and the maintenance unit at equal speed. The conveyor device can in particular comprise concatenated conveyor units, which can each be designed to unload an object resting thereon transversely to the conveyor line.

For example, the independent claim directed to the use proposes the employment of a maintenance cell in a transverse belt sorter, which replaces a conveyor cell, wherein the maintenance cell comprises sensors for inspecting the conveyor line of the transverse belt sorter. The maintenance cell and the conveyor cells are moved or operated jointly or at equal speed, including standstill.

The conveyor device typically designates a facility which is provided to transport objects from one location to another and/or to distribute them between locations. The conveyor device is generally automated, which in particular includes a control via computer systems.

The conveyor device can comprise, for example, belts, rollers, rails, drives, and/or other technical means to convey the objects. For example, the conveyor device can comprise a moving conveyor belt, in particular when the conveyor belt is to be understood as a conveyor unit.

The conveyor device is arranged or provided in particular in a production facility, postal distributing center, letter distributing center, and/or other logistical and/or producing institutions. In particular, the conveyor device can be provided in a storage hall or production hall, for example, for conveying objects as stored goods and/or production goods.

“Objects” can be shipments or arbitrary transport goods or objects, which can be moved on a conveyor line. For example, the objects can be pieces of luggage, suitcases, cans, bottles, products, merchandise, a material flow, bulk goods, or the like.

Objects, in particular as shipments, can comprise packages, parcels, letters, letter mail, palleted goods, and the like. The object generally relates to packaged or unpackaged objects and/or documents. The object is in particular intended for transport or distribution by means of the conveyor device. Objects can have various sizes and weights or be in different conditions. The object can comprise: envelope, document envelope, mailer, cushioned envelope, packaging material, cardboard, and/or pallet. The object typically weighs at least one gram. The object can weigh multiple kilograms, for example, 10, 20, 30, 50, or more kilograms. The object can have a dimension in one direction between one or more millimeters up to one or more centimeters, decimeters, or meters. The packaging of the object can be oriented toward protecting the content of the object from damage during transport or distribution. The object or its packaging can be cushioned and/or mechanically reinforced. The object can be wrapped with adhesive tape or packaging tape. It has been recognized that poorly or unfavorably packaged objects, for example, having protruding packaging material, adhesive tape, or other projections, or also narrow objects can jam in the conveyor device. The invention can provide a remedy here with the maintenance device.

It is possible that the object is equipped with a locating system to monitor and/or control its movement during the conveying, in particular in the conveyor device. However, often there is no locating system, for which reason the present invention wishes to provide a remedy with the maintenance device. The maintenance device can insofar comprise a locating system.

The circulating conveyor line refers in particular to a part of the conveyor device which can move the objects in a continuous circuit and/or along a defined route. This conveyor line can comprise a conveyor belt or belt, a chain, and/or a rail configuration, which optionally enables the objects to return back to the starting point. For example, the conveyor line can be designed with regard to adjustability of a speed or conveyor speed and/or an integration of sorting and processing stations along the conveyor line. It is possible that stations, for example, automated loading stations and/or unloading stations, are integrated or linked to enhance functionality. The conveyor line generally comprises a/the upper side and a/the lower side. The upper side and the lower side are in particular sides facing away from one another, for example, wherein the conveyor unit separates upper side and lower side from one another. The upper side can be referred to as the first side and the lower side as the second side. The objects are typically located on the upper side or first side.

The conveyor unit is a part of the conveyor device which is moving, to be moved, and/or intended for moving objects. The conveyor device typically comprises one or more drives which can move the conveyor unit(s). Multiple drives can be arranged distributed along the conveyor line. The conveyor unit can be moved in a conveying direction or main transport direction and/or can be designed to move objects in this direction. The conveyor direction can extend in a straight line and/or curved in at least some sections. For example, the conveying direction forms a circumferentially closed or at least substantially endless, in particular annular circuit. The conveying direction can extend between ends and/or can be branched. An annular circuit having branching can also be provided.

The conveyor unit can be understood as a conveyor means of the conveyor line, in particular which is to be in contact with resting or abutting objects. The conveyor line can be designed as or can comprise a conveyor belt. The conveyor unit can insofar be a conveyor belt having a support for one or more objects and possibly for the maintenance unit. The conveyor unit is configured in particular to transport one or more objects. Multiple conveyor belts can be provided. The conveyor line can be designed as or can comprise a roller conveyor. The conveyor unit can insofar be designed as a driven and/or freely rotating roller for moving objects, wherein in particular in this case a plurality of rollers are provided.

A or the plurality of conveyor units can be provided. The conveyor unit can be one of many modular conveyor elements of the conveyor device, wherein each conveyor element can be provided for conveying individual objects. The plurality of the conveyor units or conveyor elements can be provided concatenated along the conveyor line or conveying direction, and coupled to one another, in particular pivotably. The conveyor units can insofar form a circulating or contiguous chain. The conveyor units can then be moved jointly or at the same speed. The maintenance unit can be surrounded on the front and rear by one conveyor unit in each case along the conveying direction and in particular can be coupled thereto, in particular in a similar or identical manner to conveyor units with one another. The conveyor unit and/or the maintenance unit can be rail-guided. The conveyor line can comprise a rail for the conveyor unit(s) and possibly the maintenance unit(s).

The maintenance unit refers, for example, to a system or a device which is provided to monitor or diagnose and/or to assist the status and the functionality of the conveyor line. The maintenance unit can contain sensors, cameras, and/or other instruments which can detect information about the status of the conveyor line. The maintenance unit can be remote-controllable, which can mean in particular at least one transmission of the information away from the maintenance unit to a computer device, for example, to a remote control, and optionally an operation of the maintenance unit remotely. The maintenance unit can be designed to transmit the information. The information can in particular be analyzed on the maintenance unit itself and/or at another location, for example, to plan maintenance work and/or to identify problems before they result in disturbances. The maintenance unit can comprise software tools which are configured to visualize the information and/or which can give recommendations for maintenance intervals and repairs. The maintenance unit can be battery-operated and/or can be supplied with electricity along the conveyor line or by the conveyor line. The maintenance unit can be understood as an unmanned vehicle and/or object, which can in particular move along the conveyor line, preferably with the conveyor unit or the conveyor units, in particular at equal speed. The maintenance unit can comprise its own drive and/or can be driven by the conveyor line.

Insofar as the conveyor unit is designed for unloading an object resting or conveyed thereon transversely to the conveyor line, it is possible to refer to a transverse belt conveyor or transverse belt sorter, also cross belt sorter or sorter. The transverse belt conveyor is a conveyor system which is typically conceived to move objects primarily along the conveyor direction as the main transport direction and to move them transversely to the conveying direction upon unloading. The system in particular enables objects to be displaced and/or distributed laterally to the conveying direction, whether to bring the objects to a standstill, to distribute them to a further handling station, and/or to move them to another conveyor device. The transverse belt conveyor typically has a plurality of transversely arranged conveyor belts or tiltable slides which are moved along the conveying direction. The conveyor belts or slides can be moved independently of one another to unload the objects in order to unload or distribute objects at specific points and/or stations.

The conveyor device can be designed as a shell sorter. It comprises a plurality of conveyor units having a mechanism which conveys and throws off the objects using carriers in the form of shells or chambers. The shell sorter can be designed as a tilting shell sorter, as a split tray sorter, or as a push tray sorter.

The conveyor device, in particular the transverse belt conveyor, can comprise integrated scanners or other identification systems as detection unit(s), which take part in the conveying of the objects, in particular the sorting and distributing of the objects. The detection unit refers in particular to a permanently installed monitoring and/or identification system which is designed, for example, to detect various sections and/or parts of the conveyor line and/or objects located thereon. The detection unit can comprise one or more components such as light barriers, cameras, sensors, scanners, or other measuring devices, which can in particular continuously collect data about the status of the conveyor units and the properties of the transported objects. The detection unit is typically permanently integrated and/or directly connected to the conveyor line, by which detection, monitoring, and/or data acquisition continuously or at any time is made possible. The detection unit can identify, for example, dimensions, weight, type, location, and/or status of an object. The detection unit and/or the maintenance unit can identify and/or locate technical statuses or malfunctions of the conveyor line. The information obtained by the detection unit is typically used in the distribution of objects. If a detection unit does not function or is incorrectly aligned, this can result in disturbances in operation and/or the conveyor device can come to a standstill.

The sensor system for detecting the conveyor line refers in particular to sensors, sensor arrangements, and/or units having sensors which are designed to collect information about the upper side and/or lower side of the conveyor line. The sensor system is in particular designed for detecting the conveyor line or specially configured for this purpose. The sensor system can be used to identify features such as a three-dimensional extension, a wear status, damage/defects, or other structural properties of the conveyor line. The sensor system can comprise at least one camera, an optical sensor, ultrasonic sensor, radar sensor, laser sensor, lidar sensor, infrared sensor, and/or sensor acting in a tactile manner in order to be able to obtain the information. Depending on the application, different sensors can be useful. The sensor system can be configured so that it measures static and/or dynamic properties, such as vibration patterns of the conveyor line, which can give information about the running operating state.

The actuator unit comprises in particular a movable system or aid which can carry out maintenance and repair work on the conveyor line. The actuator unit can comprise various types of actuators, in particular robot arms, tool carriers, and/or special modules or tools which can be used for maintenance work such as lubricating, cleaning, repair, replacement of worn parts, or adjustments. The actuator unit is equipped, for example, with a control system, which is configured in particular for control based on the obtained information and/or based on user commands. The actuator unit or the control system can be programmed to carry out maintenance work, for example, to disturb the operation of the conveyor device as little as possible or not at all. The maintenance unit, in particular having the actuator unit, can contribute to increasing the availability of the conveyor device in that it reduces the necessity for manual interventions and fundamentally carries them out itself. At the same time, the maintenance unit, in particular using the actuator unit, can improve the work protection in that it keeps humans away from potentially hazardous maintenance work.

The comparison of the obtained information to previously known information about the conveyor line is in particular a computer-implemented method step. The comparison refers in particular to a target-actual comparison. On the one hand, the actual environment can be detected, on the other hand, the actual environment can be compared to an original or desired target environment. In the event of sufficient deviations between the information, for example, a geometrical deviation can be concluded. Not only the presence of the geometrical deviation, but also its location can be identified on the basis of the obtained information. The localization in particular means the identification and the locating of the deviation. The comparison is advantageously used to check the function or alignment of the detection unit. Deviations between actual and target also show corresponding indications here that the detection unit is not properly aligned or does not function.

Further possible embodiments of the invention, which can advantageously be used in the conveyor device and the method, are specified hereinafter.

The maintenance unit is, for example, a unit carried along on the conveyor line. The maintenance unit can be designed so it can be set up or placed on a conveyor unit. The maintenance unit can in particular be secured on a support of a conveyor unit. The maintenance unit can also be guided on one or more conveyor units concatenated movably along the conveyor line, in particular wherein the maintenance unit in this case can form an integral component of the conveyor line. A conveyor unit can insofar be exchanged with the maintenance unit.

The conveyor device can comprise a detection unit permanently installed on the conveyor line. The detection unit can be fixed in location, i.e. not also moved upon movement of the conveyor unit(s). The detection unit can comprise a sensor and/or a light barrier, for example, by which objects can be detected and/or measured. The detection unit is typically arranged or aligned at a specific height and/or at specific angles with respect to the conveyor unit(s). The detection unit can be adjusted. With proper function of the detection unit, at a specific height, for example, it can detect objects and/or recognize whether the respective conveyor unit conveys an object.

The sensor system can comprise a camera on the upper side and/or a camera on the lower side. For example, the sensor system or the camera can be aligned in the conveying direction and/or counter to the conveying direction, and/or pointing upward or downward. The sensor system can be directed toward the closest conveyor unit(s). The sensor system can in particular detect a housing of the conveyor line. The sensor system can provide an image signal or video signal as information. The signal of the camera enables points to be maintained, objects left behind, geometrical deviations in the conveyor line, or the like to be able to be identified.

The sensor system can advantageously comprise an illumination unit for illuminating the conveyor line. The illumination unit is designed in particular for illuminating the conveyor line or especially configured for this purpose. The illumination unit comprises, for example, an LED light source, in particular in conjunction with a reflector for the light emitted by the LED light source. A camera can be combined with the illumination unit in order to obtain a particularly bright or high contrast image signal or video signal of the inner parts of the conveyor device, which are often poorly illuminated.

In particular, the sensor system can be adjustable in direction in a motorized manner. For example, a camera and illumination unit can be adjusted in direction jointly. An adjustment motor can be provided. For example, it can be provided that the sensor system is able to be adjusted in direction in an active range of at least 45°, preferably at least 90°, preferably at least 180°, in particular 360°. For example, the active range can extend in a horizontal plane of the conveyor line and around a vertical axis or height axis. Up to a complete revolution of the sensor system around the vertical axis can insofar be carried out. The sensor system can optionally also be adjusted in direction around one or two further axes in space. An inspection can thus be carried out in a targeted manner starting from the maintenance unit along the conveyor line, in particular during the operation of the conveyor device.

A remote control can be provided for remotely controlling or remotely operating the conveyor line and/or the maintenance unit. The remote control is in particular designed for remote control or remote operation or is especially configured for this purpose. The remote control is in particular designed to display the information, for example, by means of a display. The remote control can be designed as a mobile and/or battery-operated device. The remote control can be provided by a computer device, for example, laptop, smart phone, and/or tablet computer. The remote control typically comprises an input device, for example, a keyboard and/or a touchscreen, and/or an output device, for example, a display and/or loudspeaker. The remote control can be configured, for example, for the direction adjustment of the sensor system and/or the specification of a conveying speed and/or conveying direction of the conveyor line. The remote control is designed in particular for communication with the maintenance unit, for example, to transmit the information and/or to send control commands. The communication is preferably a wireless and/or bidirectional communication, for example, using a wireless communication method such as 4G, 5G, WLAN, and/or Bluetooth. The remote control facilitates the maintenance and repair of the conveyor device.

A visualization unit is preferably provided. The visualization unit can comprise a display and/or a projection device, for example, to display or visualize the information. The visualization unit is in particular designed to display the information by means of augmented reality and/or virtual reality. The visualization unit can comprise 3D glasses, VR glasses, or the like. The visualization unit can communicate, for example, with the remote control and/or the maintenance unit, in particular wirelessly and/or bidirectionally, for example, using a/the wireless communication method such as 4G, 5G, WLAN, and/or Bluetooth.

A localizing unit is preferably provided for determining a position of the maintenance unit along the conveyor line. In particular, the maintenance unit comprises a marking to optically mark a position of the maintenance unit. The marking can be a noticeable element, for example, a flag. Alternatively or additionally, a light can be provided as a marking. The localizing unit can also comprise a loudspeaker to output tones. Alternatively or additionally, the localizing unit can determine a position of the maintenance unit along the conveyor line and provide the position as part of the information. A user can more easily identify the point at which the maintenance unit is located by means of the localizing unit.

The conveyor line can comprise a housing, in particular to cover the conveyor unit laterally and/or on the lower side. The housing can be provided at least in some sections along the conveyor line. The housing can comprise openings or flaps, in particular to obtain access to the conveyor line in sections from the lateral direction. The housing preferably comprises at least one side wall or two opposing side walls. A gap can be provided between the conveyor unit and the housing or side wall, for example, having a width of at least 0.5 cm and, for example, at most 10 cm. The housing can be designed for lateral delimitation or as a peripheral delimitation of the conveyor line. The housing can be used as a peripheral delimitation on the sides of the conveyor unit(s). The housing can also be arranged below the conveyor unit in some sections. The housing in particular ensures lateral protection and possibly protection from above or below. The housing in particular protects the moving conveyor unit against inadvertent engagements by people.

The maintenance unit advantageously comprises an actuator unit, which is in particular remotely operable. The actuator unit is designed in particular to carry out maintenance work on the conveyor line or is specially configured for this purpose. The actuator unit is in particular designed to carry out movements in space or relative to the conveyor line. For example, the maintenance unit can be remotely operated by means of a/the remote control, wherein the actuator unit can carry out a controlled movement and/or maintenance work in this case. For example, the actuator unit can be designed to replace, move, and/or to deform parts or sections of the conveyor device and/or objects or can be specially configured for this purpose. The actuator unit is typically distinguished in that it can carry out an actuated relative movement in relation to the conveyor line or on a conveyor unit, in particular in relation to the maintenance unit itself away from the actuator unit. The actuator unit can be designed as electrically, hydraulically, and/or pneumatically actuatable. Multiple actuator units can also be provided, for example, one or more on the upper side and/or one or more on the lower side. The actuator unit typically comprises one or more drives.

The actuator unit can advantageously comprise a robot arm or be formed by a robot arm, in particular wherein the robot arm is provided with the sensor system and/or a tool, preferably for moving an object, or comprises this. The tool is in particular designed for moving an object or is specially configured for this purpose. The tool can comprise a gripper, for example. Multiple tools can be provided in particular on a robot arm. The robot arm typically comprises a plurality of pivot axes spaced apart from one another and at least one robot arm element comprising at least two of the pivot axes. Experience has shown that a robot arm is very flexible with respect to occurring repairs and maintenance work.

In the method proposed here, a geometrical deviation can be localized by comparing the obtained information with previously known information. The geometrical deviation can comprise an object which has been left behind and/or jams. Alternatively or additionally, the geometrical deviation can comprise a housing of the conveyor line which is open and/or defective at least in some sections. The geometrical deviation can also be a particularly heavy soiling. It has been shown that these geometrical deviations are a frequent source of faults in operation of the conveyor device. In addition, it has been shown that these geometrical deviations can be identified well by the method offered. For example, the conveyor line can be monitored and/or inspected by means of the comparison during operation in order to identify problems and remedy their cause quickly.

In the method proposed here, the function and/or alignment of the detection unit can be checked by comparing the obtained information with the previously known information. For example, it can be established at which height the detection unit or the light barrier is set, how it is aligned, and/or whether it functions properly. A signal check of the detection unit can be carried out. Overall, the functionality of the conveyor device can thus be checked, for example, to be able to intervene in the event of irregularities. For example, the conveyor line can be detected in one section using the detection unit. The previously known information can relate in particular to the detection unit or the section having the detection unit. The comparison can insofar relate in a focused manner to the detection unit in order to ensure its functionality.

The conveyor line can be detected in a circulating manner. For example, the conveyor line can be detected continuously, during each pass, and/or essentially permanently, to be able to react to problems in real time as much as possible. The conveyor line may thus alternatively or additionally be detected at regular time intervals, for example, hourly or daily, in order to save resources.

The operation and the detection and optionally the comparison can be carried out at the same time. The steps of the method can be carried out overlapping in time or also in succession. In principle, the detection can be carried out during the movement and also independently of the movement. The comparison can also be placed later in time, for example, in that firstly the information is collected and later it is evaluated by the comparison. Preferably, operation, detection, and comparison are carried out simultaneously to be able to identify problems on the conveyor line as quickly as possible.

The maintenance unit can be secured on the and/or below the conveyor unit, in particular thereon. For example, the maintenance unit can be fastened and/or fixed on the respective conveyor unit. It is thus ensured that the information obtained is as uniform as possible at different times. The uniformity of the obtained information can also be improved in conjunction with the housing.

Generating the previously known information by initially detecting the conveyor line by means of the maintenance unit can be provided. The initial detection is preferably carried out when the conveyor line is ready for operation to convey objects and is in an initial status. In other words, the conveyor line is to be free of faults and in the ideal status when the previously known information is detected. It is also conceivable that obtained information is made previously known information to be able to recognize spontaneously occurring and/or minimal geometrical deviations.

In the method, the maintenance unit can be remotely operated, in particular wherein the information is displayed and/or stored by means of a/the remote control and/or a/the visualization unit, which is designed to display the information by means of augmented reality and/or virtual reality. For example, a user can remotely control the conveyor line to move the maintenance unit to the geometrical deviation and/or to the detection unit, in particular while the user receives a visual view into the interior of the conveyor device.

In the method, the maintenance unit can carry out maintenance work. The maintenance work can be carried out by a user command and/or in a user-controlled manner. The maintenance work can comprise a repair of the conveyor line and/or a movement of an object left behind and/or an alignment and/or check of the function of the detection unit. For example, parts of the conveyor device can be inspected, repaired, and/or replaced. The detection unit can be vertically adjusted and/or a signal check of the detection unit can be carried out. Finally, it can be provided in the method that maintenance or repair is carried out on the conveyor line. In particular a local defect, for example, an object left behind, a geometrical deformation, and/or a misaligned detection unit can be remedied with the aid of the actuator unit and in particular controlled by means of the remote control and/or the visualization unit, by user operation. For example, the maintenance unit can set or adjust the detection unit, in particular automatically.

Data on the maintenance work carried out can be stored in a database. Repeating maintenance work can be carried out in an automated manner in consideration of the stored data. The database can be provided by the maintenance unit, the remote control, a central computer device, and/or a cloud. In particular, a learning system can be provided, in which maintenance work or repairs already carried out are stored and can be carried out later automatically according to already known patterns upon renewed occurrence. The repeating maintenance work can relate not only to repairs, but also objects which are left behind or jammed or alignment or checking of the detection unit. For example, it is possible that a maintenance and/or repair of a specific point of the conveyor line is carried out in an automated manner when the maintenance unit has been trained accordingly. For example, a lubrication of specific mechanical parts can be automated. Points of the conveyor device susceptible to jamming of objects can also be handled in an automated manner by moving the object by means of the maintenance unit.

The geometrical deviation can comprise particularly heavy soiling and/or a point of the conveyor line which is to be cleaned or is soiled. The maintenance unit can be designed for cleaning the conveyor line and/or the detection unit. For example, the maintenance unit can comprise cleaning means or a cleaning tool, for example, a brush or a compressed air nozzle for directed output of compressed air. The robot arm can be designed for cleaning. For example, the cleaning means or cleaning tool can be used by means of the robot arm on the conveyor line. In the method, cleaning by the maintenance unit can be provided, for example, cleaning of the conveyor line and/or the detection unit, in particular with mechanical contact (for example, a brush) and/or contactlessly (for example, compressed air).

In the context of the disclosure, the German abbreviation “bzw.” stands as a short form for “beziehungsweise [respectively; or]” and is to specify fundamentally alternative, basically equivalent and/or synonymous features or terms to more closely convey the idea or the sense of a use of a feature or term. “Beziehungsweise” can always be replaced with “und/oder [and/or]”.

The invention will be described in more detail hereinafter on the basis of a preferred exemplary embodiment with reference to the drawings.

In the drawings

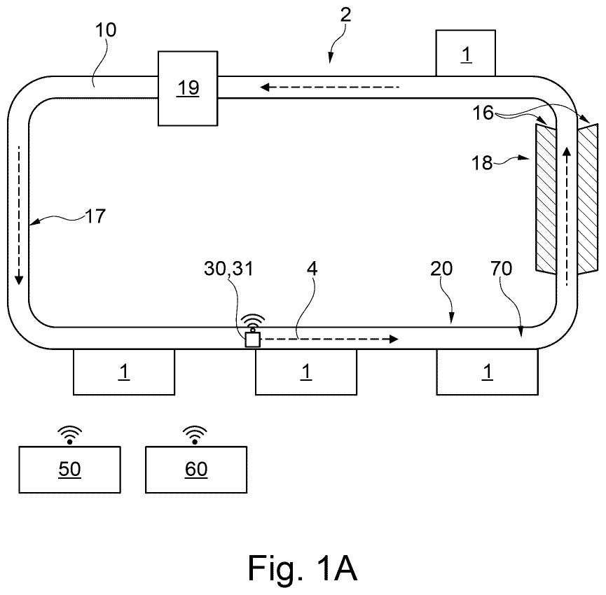

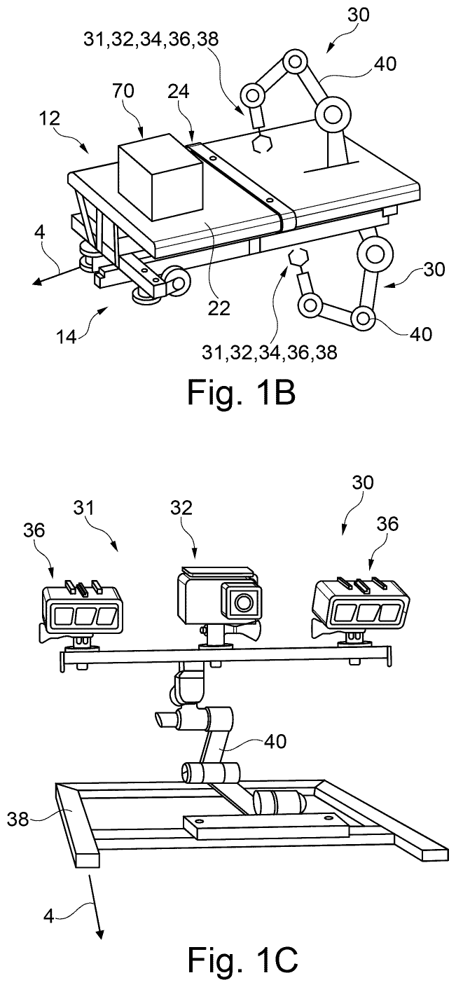

FIG. 1A shows a conveyor device for conveying objects and having maintenance units in a schematic view,

FIG. 1B shows a maintenance unit and a conveyor unit of the conveyor device coupled concatenated thereon in a perspective view, and

FIG. 1C shows a maintenance unit of the conveyor device in a perspective view.

FIG. 1A shows a conveyor device 2, which is designed for conveying objects 70, comprising a conveyor line 10 circulating endlessly or annularly or circularly along a conveyor direction 4. A plurality of conveyor units 20 (not shown in detail) and a maintenance unit 30 are movably guided concatenated or coupled with one another along the conveyor line 10. Drives 17 along the conveyor line can move this chain made up of the conveyor units 20 and the maintenance unit 30 to circulate.

A further maintenance unit 30 is set up on one of the conveyor units 20 or secured thereon. The conveyor units 20 are each designed to unload an object 70 resting or conveyed thereon transversely to the conveyor line 10. Multiple sorting or processing stations 1 are attached on the outside to the conveyor line 10, by which objects 70 can be loaded onto the conveyor units 20 or can be unloaded from the conveyor units 20 to the stations 1. In particular, the conveyor device 2 is designed as a transverse belt sorter or transverse belt conveyor. Alternatively or additionally, the conveyor device 2 is designed as a shell sorter.

In the present case, these are remotely-controllable or remotely-operable maintenance units 30, i.e. the maintenance units 30 can send information and optionally receive and carry out commands.

A conveyor device having a conveyor line, wherein precisely one conveyor unit is movably guided along the conveyor line, is not shown. For example, this could be a belt conveyor, wherein a maintenance unit is set up on the belt conveyor or secured thereon and also conveyed. The belt conveyor can be designed as circulating endlessly or also as a line section having at least two ends.

A conveyor device having a conveyor line, wherein multiple or a plurality of conveyor units for conveying objects are movably arranged along the conveyor line, is not shown. For example, this could be a roller conveyor, wherein a maintenance unit is set up on the roller conveyor and also conveyed. The roller conveyor can be designed as circulating endlessly or also as a line section having at least two ends.

Furthermore, a detection unit 19 permanently installed on the conveyor line 10 is provided in FIG. 1A, which has an upper-side light barrier, for example, having the function of detecting objects 70 at a specific height or not detecting them depending on the height. The detection unit 19 is adjustable or can be aligned.

The conveyor line 10 comprises a housing 16, in order to cover the conveyor units 20 and the maintenance units 30 laterally and optionally on the lower side. The housing 16 can be opened in sections, for example, by means of lids 18 or flaps, to obtain access to the conveyor line 10. The lids 18 or flaps can be understood as railings.

It is possible that objects 70 jam or get into a gap between conveyor units 20 and the housing 16. This is referred to as an object 70 which is left behind or a shipment which is left behind. If objects 70 are comparatively flat, they can also get into the area below the conveyor line 10, thus the lower side.

FIG. 1B shows, in a detail of the conveyor device 2 of FIG. 1A, a single conveyor unit which is coupled to the maintenance unit 30 for joint movement concatenated on one another. The conveyor units 20 each comprise a support 22 for placement of the objects 70, which can be tilted transversely to the conveying direction 4 to unload the respective placed objects 70 and/or which is a conveyor belt oriented transversely to the conveyor direction 4, which can convey off or unload the respective placed objects 70 transversely to the conveying direction 4. The conveyor units 20 are coupled with one another and likewise the conveyor unit 20 shown is coupled with the maintenance unit 30 in a coupling area 24. The coupling area 24 provides freedom of movement, for example, in curves of the conveyor line 10.

The maintenance unit 30 of FIG. 1B, like the conveyor units 20 as well, is rail-guided in the present case and can be moved with the conveyor units 20 at equal speed. The maintenance unit 30 can be viewed as a maintenance cell. The maintenance unit 30 comprises two remotely-operable actuator units 40 in the present case, which are designed to carry out maintenance work on the conveyor line 10, wherein the actuator units 40 each comprise a robot arm, and wherein the respective robot arm is provided with a sensor system 31 and a tool for gripping and moving an object 70.

The tool can comprise a suction unit and/or a device for gripping objects 70 by means of negative pressure. Objects 70 can thus optionally be suctioned on in order to be temporarily secured on the tool and to be able to be moved.

The sensor system 31 is designed in each case to detect the conveyor line 10 to obtain information on an upper side 12 and a lower side 14 of the conveyor line 14. The sensor system 31 comprises a camera 32 on the upper side 12 and a camera 34 on the lower side 14. Furthermore, the sensor system 31 comprises an illumination unit 36 for illuminating the conveyor line 10, preferably from the inside and/or in the field of view of the camera 32, 34. The sensor system 31 is adjustable in direction in a motorized manner. In particular, the camera 32, 34 and/or the respective robot arm can be adjusted in direction.

The maintenance unit 30 optionally comprises a localizing unit 38 for determining a position of the maintenance unit 30 along the conveyor line 10. The maintenance unit 30 comprises a marking, for example, a flag, to optically mark a position of the maintenance unit 30, in particular so it is easily recognizable from the outside.

FIG. 1C shows the further maintenance unit 30 of the conveyor device 2, which can be secured on a conveyor unit 20, for example, placed and/or fastened thereon, in order to be moved along the conveying direction 4. The maintenance unit 30 comprises a camera 32 on the upper side 12 and at least one illumination unit 36. The camera 32 and the illumination unit 36 are optionally adjustable in direction via an actuator unit 40. Alternatively or additionally to the actuator unit 40, a manually adjustable arm can also be provided.

In consideration of FIG. 1A, a remote control 50, which is designed for remote operation of the conveyor line 10 and the maintenance units 30, in particular the actuator units 40, is provided, wherein the remote control 50 is designed to display the information. The maintenance units 30 can send the information. The remote control 50 can store the information, for example, in a database. The remote control 50 is designed for wireless communication with the maintenance units 30 and optionally with the conveyor line 10. The conveyor device 2 can be moved and/or a camera 32, 34 or one of the robot arms can be adjusted in direction via the remote control 50, in particular by a user input. The information obtained by the sensor system 31 is at least partially visible on the remote control 50. For example, a user can identify whether and where an object 70 has jammed.

A smart phone, a tablet, and/or a computer having display screen can be used as the remote control 50, which can communicate via a wireless communication method, for example, 4G, 5G, WLAN, and/or Bluetooth, with the maintenance unit(s) 30.

A visualization unit 50 is optionally provided, which is designed to display the information by means of augmented reality and/or virtual reality. This unit can involve VR glasses, which a user involved with maintenance of the conveyor device 2 wears. The visualization unit can communicate with the maintenance unit(s) 30 in cooperation with the remote control 50 or as such, in order to display the content and/or to control the conveyor line 10 and/or the maintenance unit 30. The visualization unit 50 can communicate via a wireless communication method, for example, 4G, 5G, WLAN, and/or Bluetooth, with the maintenance unit(s) 30 and/or the remote control 50.

An operating method of the conveyor device 2 comprises moving the maintenance unit 30 or the maintenance units 30 along the conveyor line 10, in particular in that the conveyor units 20 are moved. The maintenance unit 30 is in particular moved by application of force of the drive 17 and in particular via the conveyor units 20. The operating method is in particular at least partially computer-implemented.

The operating method furthermore comprises detecting the conveyor line 10 by means of the maintenance unit(s) 30 to obtain the information. The sensor system 31 detects the upper side 12 and the lower side 14, so that a user can have an optical view into points of the conveyor line 10 which are difficult to reach and/or are enclosed by the housing.

The operating method furthermore comprises comparing the obtained information with previously known information about the conveyor line 10. The comparison is provided, for example, to check the function and alignment of the detection unit 19 and to localize a geometrical deviation in the conveyor line 10. The geometrical deviation can be an object 70 which has been left behind or jammed or also soiling and a housing 16 that is open or defective in sections.

In the operating method, the conveyor line 10 is detected all around by means of the maintenance unit 30. It is thus rapidly recognized whether and where a geometrical deviation is present. The operation, the detection, and the comparison are carried out at the same time, wherein in particular the detection and the comparison are predominantly or substantially computer-implemented steps.

Alternatively or additionally, the conveyor line 10 is detected in the section having the detection unit 19, wherein the previously known information relates to the detection unit 19. In principle, the operating method can be focused here on the inspection or maintenance of the detection unit 19.

In the operating method, the maintenance unit 30 can carry out maintenance work by means of the actuator unit 40, wherein the maintenance work comprises repairing the conveyor line 10 and moving an object 70 that has been left behind and aligning and checking the detection unit 19. It is possible that data on the maintenance work carried out are stored in a database, wherein repeating maintenance work can be carried out in an automated manner in consideration of the stored data. The maintenance unit 30 or its actuator unit 40 is in particular remotely-operable by means of the remote control 50. A user can advantageously use the visualization unit 60 in order to have the geometrical deviation displayed as an overlay on the conveyor device 2 in his field of view. The user can thus deliberately remote-control the maintenance unit 30 from the outside in order to remove or repair the geometrical deviation or to carry out maintenance work.

The operating method furthermore provides generating the previously known information by initially detecting the conveyor line 10 by means of the maintenance unit 30 when the conveyor line 10 is operationally ready to convey objects 70 and is in an initial status. A proper original status or factory status of the conveyor line 10 can insofar be established to be able to identify geometrical deviations well in the obtained information.

The maintenance unit 30 has various possible uses. In the operating method, objects 70 which are left behind can be moved by means of the maintenance unit 30. Soiling can be recognized as geometrical deviations by means of the maintenance unit 30 and in particular can be eliminated by cleaning by means of the maintenance unit 30. The detection unit 19, if it is misaligned, can be aligned by means of the maintenance unit 30. An open housing 16, for example, open security equipment, can be recognized by means of the maintenance unit 30 and it can be closed if necessary or this can be reported. Damage to the housing 16 or to side walls can be recognized by means of the maintenance unit 30 and this can possibly be repaired or this can be reported.

A development is shown and described in particular, wherein a maintenance cell or maintenance unit 30, for example, one like that from FIG. 1B, is introduced in place of a sorter sell or conveyor unit 20 in a sorter or a conveyor device 2, in particular a transverse belt sorter or transverse belt conveyor. The maintenance cell is distinguished in that the environment can be detected in an accompanying manner sensorially, in particular by light optics using cameras 32, 34, above and below the sorter or the conveyor line 10, thus on the upper side 12 and the lower side 14. Remote operability of the maintenance cell and the sorter is provided. Soiling, objects 70 which have been left behind, defects, missing covers, and the like can be recognized in a manually-operated process. A user or operator can wear the visualization unit 60 in the form of VR glasses and/or carry out observations from the maintenance cell from the computer. The maintenance cell or maintenance unit can observe the conveyor line 10 in sections and/or progressively when the conveyor device 2 is operated. It can be established in an automated manner whether and where an object 70 has jammed or other geometrical deviations or need for maintenance, for example, on the detection unit, have arisen. This is achieved in particular by the automated target-actual comparison by the method step “comparing”. In other words, for example, environmental differences can be compared, which can be achieved due to a target environment of the conveyor line defined at least in some sections, in particular thanks to a housing 16. The position of a “problem point” (object 70 which has jammed/been left behind, geometrical deviation, detection unit to be checked or adjusted, etc.) can be localized in an automated manner in order to be able to plan or carry out corresponding maintenance work or repairs.

A further embodiment of the development provides that the maintenance unit 30, for example, one like that from FIG. 1C, is moved in a conveyor device 2 by one or more conveyor units 20. The conveyor device 2 can be a conveyor belt and/or a roller conveyor. In principle, it can be provided that the maintenance unit 30 is also moved or conveyed like an object 70. The maintenance unit 30 can in this case sensorially detect the environment in an accompanying manner, for example, by light optics using a camera 32, at least above the conveyor line 10 of the conveyor device 2 or on the upper side 12. Remote operability and/or features can also be provided here, as stated in the preceding paragraph.

A conveyor device 2 for conveying objects 70 is illustrated and described, comprising a circulating conveyor line 10, along which a plurality of conveyor units 20 and a maintenance unit 30 are guided so they are movable in a concatenated manner, wherein the conveyor units 20 are each designed to unload an object 70 resting thereon transversely to the conveyor line 10, and wherein the maintenance unit 30 comprises an actuator unit for carrying out maintenance work on the conveyor line 10.

A use is illustrated and described of an in particular remote-controllable maintenance unit 30 having an actuator unit 40 for carrying out maintenance work of a conveyor line 10 of a conveyor device 2 designed for conveying objects 70 in an operation of the conveyor device 2 moving the conveyor line 10 and the maintenance unit 30 at equal speed, wherein the conveyor device 2 comprises concatenated conveyor units 20, which are each designed to unload an object 70 resting thereon transversely to the conveyor line 10.

### LIST OF REFERENCE NUMERALS

2 conveyor device
4 conveying direction
5 conveyor line
12 upper side
14 lower side
16 housing
17 drive
18 cover
19 detection unit
20 conveyor unit
22 support
24 coupling area
25 maintenance unit
31 sensor system
32 camera (upper side)
34 camera (lower side)
36 illumination unit
38 localizing unit
40 actuator unit
50 remote control
60 visualization unit
70 object

1. A conveyor device for conveying objects, comprising a circulating conveyor line, along which a plurality of conveyor units for placement of the objects and a maintenance unit are movably guided in a concatenated manner, wherein
the conveyor units are each designed to unload an object resting thereon transversely to the conveyor line, and
the maintenance unit comprises an actuator unit for carrying out maintenance work on the conveyor line.

2. The conveyor device according to claim 1, wherein the actuator unit comprises a robot arm.

3. The conveyor device according to claim 1, wherein at least one of the actuator unit and the actuator unit on the robot arm comprises a tool.

4. The conveyor device according to claim 3, wherein the tool is designed for moving an object.

5. The conveyor device according claim 1, wherein at least one of the maintenance unit and the maintenance unit on the robot arm comprises a sensor system for detecting the conveyor line to obtain information about at least one of an upper side and a lower side of the conveyor line.

6. The conveyor device according to claim 5, wherein the sensor system comprises at least one of a camera on the upper side and a camera on the lower side.

7. The conveyor device according to claim 5, wherein the sensor system comprises an illumination unit for illuminating the conveyor line.

8. The conveyor device according to claim 7, wherein the sensor system is adjustable in direction in a motorized manner.

9. The conveyor device according to claim 6, comprising a remote control for remotely operating at least one of the conveyor line and the maintenance unit, wherein the remote control is designed to display the information.

10. The conveyor device according to claim 1, wherein the remote control is designed for wireless communication with the maintenance unit.

11. The conveyor device according to claim 6, comprising a visualization unit,
which is designed to display the information by means of at least one of augmented reality and virtual reality.

12. The conveyor device according to claim 1, comprising a localizing unit for determining a position of the maintenance unit along the conveyor line.

13. The conveyor device according to claim 12, wherein the maintenance unit comprises a marking to optically mark a position of the maintenance unit.

14. The conveyor device according to claim 1, wherein the conveyor line comprises a housing to laterally cover the conveyor unit.

15. A method for operating the device according to claim 5, comprising
moving the conveyor unit and the maintenance unit along the conveyor line, and
detecting the conveyor line by means of the maintenance unit to obtain the information.

16. The method according to claim 15, comprising
comparing the obtained information with previously known information about the conveyor line, wherein the comparison is intended at least one of to check at least one of the function and the alignment of a detection unit permanently installed on the conveyor line and to localize a geometrical deviation in the conveyor line.

17. The method according to claim 15, wherein the maintenance unit is remotely operated and the information is at least one of displayed and stored.

18. The method according to claim 15, wherein the maintenance unit carries out maintenance work, and wherein the maintenance work comprises at least one of a repair of the conveyor line, a movement of an object which has been left behind, an alignment of the detection unit and check of the detection unit.

19. The method according to claim 18, wherein data on the maintenance work carried out are stored in a database, and wherein repeating maintenance work is carried out in an automated manner in consideration of the stored data.
